(19) United States
(12) Patent Application Publication
(10) Pub. No.: US 2007/0038475 A1
(43) Pub. Date: Feb. 15, 2007

(54) Dynamic healthcare modeling

(75) Inventors: Leonard Schlessinger, Pacific Palisades, CA (US); David Eddy, Aspen, CO (US)

Correspondence Address: MORRISON & FOERSTER LLP, 425 MARKET STREET, SAN FRANCISCO, CA, 94105-2482, US

(73) Assignee: Archimedes, Inc., San Francisco, CA (US)

(21) Appl. No.: 11/503,393

(22) Filed: Aug. 11, 2006

Related U.S. Application Data
(60) Provisional application No. 60/707,696, filed on Aug. 12, 2005.

(51) Int. Cl. G06Q 10/00; G10L 11/00

(52) U.S. Cl. 705/2; 704/202

(57) ABSTRACT

A method for simulating a clinical trial includes: selecting a trial procedure for a simulated trial corresponding to the clinical trial; generating a population of subjects for the simulated trial; searching the population of subjects to determine acceptable subjects for the simulated trial; selecting subjects for the simulated trial from the acceptable subjects; simulating the trial procedure for the selected subjects; and collecting trial data for the simulated trial from the simulated trial procedure.

### CROSS-REFERENCE TO RELATED APPLICATIONS

This application claims the benefit of U.S. Provisional Application No. 60/707,696, filed Aug. 12, 2005, and incorporated herein by reference in its entirety.

### FIELD OF THE INVENTION

The present invention relates to the healthcare modeling. More particularly, the present invention relates to dynamic healthcare modeling including applications to clinical trials and to diabetes management and prevention.

### BACKGROUND OF THE INVENTION

Mathematical models are in widespread use in various technologies related to computer hardware and software. In specific contexts these mathematical models can be developed and applied to focused applications where the goals may include the prediction and optimization of performance measures that depend on complex interactions between related system components.

In the context of healthcare, many challenges remain for applying these models. Delivering high quality healthcare efficiently generally requires making a large number of decisions as to which treatments to administer to which patients at what times and using what processes. While every conceivable alternative can be tried in an experimental setting (e.g., a clinical trial) to empirically determine the best possible approach, such an exhaustive approach is generally impossible to carry out as a practical matter. Prohibitive factors include, for example, the typically large number of possible interventions and various requirements for cooperation from patients as well as healthcare professionals. Difficulties associated with collecting data, getting patients and practitioners to comply with experimental designs, and the financial costs of the experiment, among other factors, can contribute to making an experimental approach impractical. Therefore it is highly desirable to use mathematical models in the development and implementations of high quality healthcare.

Presently, mathematical models are generally used to address very narrow healthcare questions, such as the frequency of a particular screening test. These models are often based on discrete structures that cannot adequately model continuous (or smoothly changing) features over arbitrary periods of time. In addition, these models generally do not include other potentially critical factors such as intervention events that may occur over the range of the simulation or dependency relationships between various modeling parameters (e.g., for relating biological features with various diseases).

As one specific application to healthcare, diabetes creates a number of challenges not only because of the enormous personal and societal costs associated with the disease but also because of the difficulties associated with its adequate modeling. Diabetes is a disorder of carbohydrate metabolism, usually occurring in genetically predisposed individuals, characterized by inadequate production or utilization of insulin and resulting in excessive amounts of glucose in the blood and urine, excessive thirst, weight loss, and in some cases progressive destruction of small blood vessels leading to such complications as infections and gangrene of the limbs or blindness. Type 1 diabetes is a severe form in which insulin production by the beta cells of the pancreas is impaired, usually resulting in dependence on externally administered insulin, the onset of the disease typically occurring before the age of 25. Type 2 diabetes is a mild, sometime asymptomatic form characterized by diminished tissue sensitivity to insulin and sometimes by impaired beta cell function, exacerbated by obesity and often treatable by diet and exercise.

To a limited extent, models have been created in the past in an attempt to simulate the course of diabetes in patients. Typically these models split time into intervals, and only measure or report findings at discrete time periods (e.g., once a month). In some cases, features are split into relatively crude states (e.g., dead vs. alive, or coronary artery disease vs. no coronary artery disease) and these states may only change at the discrete time periods. Furthermore, these models are generally based on statistical analyses of reported patient data and not on actual human physiology. Thus, not only are these models typically inadequate (e.g., in the sense that they do not adequately relate the patient's physiology to the disease), they are difficult to validate before or even during their use. Any limited validation must wait until after the patient's disease has run its course. Diabetes, however, is a chronic disease. Additionally, significant amounts of money are spent on clinical trials to test new drugs and procedures on patients. Validating a model's accuracy before the trial begins can save money, and perhaps patients' lives, by allowing the researchers to modify the clinical trial before it starts.

Thus, there is a need for improved dynamic healthcare models with applications to diseases such as diabetes and operational settings such as clinical trials.

### SUMMARY OF THE INVENTION

In one embodiment of the present invention, a method for simulating a clinical trial includes: selecting a trial procedure for a simulated trial corresponding to the clinical trial; generating a population of subjects for the simulated trial; searching the population of subjects to determine acceptable subjects for the simulated trial; selecting subjects for the simulated trial from the acceptable subjects; simulating the trial procedure for the selected subjects; and collecting trial data for the simulated trial from the simulated trial procedure.

According to one aspect of this embodiment, selecting the trial procedure for the simulated trial may include: determining one or more criteria for inclusion or exclusion of the subjects; and determining one or more treatment protocols for the subjects. Further, the one or more criteria may include a range for fasting plasma glucose (FPG).

According to another aspect, generating the population of subjects for the simulated trial may include: determining one or more parameters for characterizing the subject at an initial state of the simulated trial, wherein the or more parameters satisfy a statistical criterion for a population corresponding to the clinical trial. Further the statistical criterion may include a coronary death rate.

According to another aspect, searching the population of subjects to determine acceptable subjects for the simulated trial includes: comparing features of subjects with criteria from the trial procedure. Further, the criteria from the trial procedure may include a positive characterization of diabetes.

According to another aspect, selecting subjects for the simulated trial from the acceptable subjects may include: selecting a pre-determined number of subjects for the simulated trial; confirming the selection by determining at least one statistical criterion for accepting the selected subjects; and adjusting the selected subjects if the at least one statistical criterion is not satisfied. Further, the at least one statistical criterion may include a characterization for the incidence of diabetes.

According to another aspect, simulating the trial procedure for the selected subjects may include: separating the subjects into at least two groups, including a control group and a treatment group, wherein the trial procedure includes a control-group trial procedure for the control group and treatment-group trial procedure for the treatment group; and advancing a temporal variable to determine at least one trial event specified by the trial procedure. Further, the at least one trial event may include a glucose measurement for at least one subject. Further, the at least one trial event may include a coronary event for at least one subject.

According to another aspect, collecting trial data for the simulated trial may include recording values for fasting plasma glucose (FPG) of the subjects at a plurality of times.

According to another aspect, the method may further include: analyzing the trial data from the simulated trial procedure to determine a comparison between the trial data and a set of clinical results from the clinical trial. Further, the comparison may include a comparison of coronary events between the simulated trial and the clinical trial.

Additional embodiments relate to an apparatus that includes a computer that executes instructions for carrying out any one of the above-described methods. For example, the computer may include a processor with memory for executing at least some of the instructions. Additionally or alternatively the computer may include a specialized microprocessor or other hardware for executing at least some of the instructions. Additional embodiments also relate to a computer-readable medium that stores (e.g., tangibly embodies) a computer program for carrying out any one of the above-described methods with a computer. In these ways the present invention enables improved dynamic healthcare models with applications to diseases such as diabetes and operational settings such as clinical trials.

### BRIEF DESCRIPTION OF THE DRAWINGS

FIG. 1 shows an embodiment of the present invention as applied to simulating a clinical trial.

FIG. 2 shows a description of equations for to an embodiment related to FIG. 1.

FIGS. 3, 4, 5, 6, and 7 show simulated trial results compared with actual trial results for embodiments related to FIG. 1.

### DETAILED DESCRIPTION OF EXEMPLARY EMBODIMENTS

Exemplary embodiments discussed below relate specifically to the simulation of dynamic healthcare models with applications to clinical trials for diabetes management and prevention. The discussion includes issues related to programming environment, dynamic modelling of human physiology, and simulation of clinical trials. Those skilled in the art will readily recognize that the disclosed embodiments can be extended to cover other healthcare issues and other operational settings.

This application is related to U.S. application Ser. No. 10/025,964 (filed Dec. 19, 2001, published as U.S. 2005/0288910 A1), which discloses continuous models applicable to healthcare features, and U.S. application Ser. No. 10/763,653 (filed Jan. 22, 2004, published as U.S. 2005/0125158 A1), which discloses models that are specifically focused to diabetes. Each of these applications is incorporated herein by reference in its entirety.

1. Programming Environment: Object Oriented Programming

Although not essential for practicing embodiments of the present invention, Object-Oriented Programming can be advantageous in many operational settings. Object-Oriented Programming is well-know to those skilled in the art of computer simulation. (Grady Booch, Object-Oriented Design with Applications, The Benjamin/Cummings Publishing Co., Inc., Redwood City, Calif. 1991.) This approach has several powerful features applicable to human physiology and healthcare. Virtually any aspect of reality, either tangible or conceptual, can be represented as an “object.” Examples of possible objects in healthcare modelling include lungs, chest pain, a patient's memory, a laboratory test, and an office visit. Objects can be organized in a logical hierarchy, beginning with “classes” (e.g., facilities), which can have “sub-classes” (e.g., hospitals), which can have sub-sub-classes (e.g., emergency departments), down to any desired level of detail. All classes of objects at every level in the hierarchy can have specific examples (called “instances” in the object-oriented terminology). Thus John Doe and Mary Smith are specific examples (instances) of the class “person.” John Doe's heart is an instance of the class “heart.” For every class of objects at every level in the hierarchy it is possible to give the instances “attributes” (e.g., characteristics) and “functions” (things they can do). Attributes and functions (also called “instance variables” and “methods”, respectively) that are defined for a class of objects at a particular level in the hierarchy are inherited by every instance of that class and by all the instances of all of its subclasses. The specific values of the attributes and the executions of the functions can be unique for every instance of a class of objects. The functions of any instance of a class of objects can depend on its own specific attributes, as well as on the specific attributes and functions of other objects.

The hierarchical structure, the ability of classes to inherit characteristics and functions from the classes above them, and the ability to address interactions between the objects in any class enable the creation of very realistic and powerful models for healthcare. An example is human anatomy and physiology. As an example of one possible hierarchical path that can be modelled in this way, each patient has a physiology, which includes organs, one of which is the heart, which has four coronary arteries, one of which is the left anterior descending artery (LAD), a function of which is to carry blood to the heart muscle (myocardium). The LAD has a channel (lumen), which can have an atherosclerotic plaque at any point, which can affect the blood flow downstream of that point, which can affect the myocardium's contractility (a function of the myocardium), which, among other things, can cause pain (a type of symptom object) which has an intensity (one of the attributes of the symptom object “pain” ) and a function (e.g., to inform the patient's mind—another part of the patient's physiology—that something is wrong with the heart). Different types of objects at any level in the hierarchy can interact. For example, when a person (an instance of the class “patient”) with chest pain (a type of symptom object) telephones a call center (a type of facility object), the call will be answered by an operator (a type of health-care-provider object), who will refer to a protocol (a type of policy/procedure object) to provide appropriate advice (a type of message object). All of these features can be modelled in this framework.

Time can be handled through an object called an “event-queue.” For every object in the model we define the events of interest that relate to that object. At any instant, the equations in the model can be used to calculate for every object in the model the time of the next event affecting that object, as a function of all the other variables in the model. The event queue is an ordered list of all the upcoming events that will affect any of the objects, and the times those events will occur. When an event occurs to any object, the model calculates the effects of that event on every other object and then updates the queue. The model then goes to the time of the next event and repeats the process. In this way, the sequence of events occurring in the model will be as condensed (e.g., minute-to-minute for the registration of chest pain by John's brain, and the placing of a call to the hospital) or as drawn out (e.g., years between any health-related events for a healthy man in his 30s) as needed. The model does this for every object and variable in every simulated person in the model, usually thousands of people.

A final strength of the object oriented approach is that the hierarchical structure makes it very easy to add, delete or modify classes of objects and the attributes and functions of objects, at any level in the hierarchy. Whenever an attribute or function is added or changed for a class of objects, the addition or change is automatically inherited by all of the instances of that class and its subclasses. Two practical implications of this are that the model is easy to update when new information becomes available, and the model can be expanded or pruned for particular applications.

Although there are clear advantages to using object-oriented programming in this context, those skilled in the art of computer simulation will appreciate that other programming constructs may be used advantageously depending on the operational setting.

2. Modelling Human Physiology and Disease

General modelling issues have been discussed above (and in U.S. application Ser. No. 10/025,964). This discussion focuses on specific embodiments related to clinical trials for diabetes management and prevention. Alternative embodiments similarly relate to other diseases (or medical conditions) including, for example, CHF (congestive heart failure) and asthma.

One can conceptualize the physiology of a person as a collection of continuously interacting objects or “features.” The concept of a feature is very general, but they correspond roughly to anatomic and biological variables. Examples include systolic and diastolic blood pressures, stenosis of a coronary artery, cardiac output, visual acuity, and amount of protein in the urine. Features can represent real physical phenomena (e.g., the number of milligrams of glucose in a decilitre of plasma), behavioural phenomena (e.g., ability to read an eye chart), or conceptual phenomena (e.g., the “progression” or “spread” of a cancer). Features can be continuous, categorical, count or dichotomous, corresponding to the type of the variable it is representing in reality; as in reality, the great majority are continuous. A large-scale model may contains hundreds of features, corresponding roughly to the variables discussed in medical textbooks and written in patients' charts. When particular features for a disease are central to the occurrence, progression and treatment of a disease, we call them “primary features.”

In the various embodiments discussed here, features define diseases, cause symptoms, are the things measured by tests, respond to treatments, and cause health outcomes. At any moment, every feature in every patient has a value (e.g., on February 20 at 8:45 AM John's systolic blood pressure=137 mmHg). The values of most features change continuously over time, causing every feature in every individual to have a trajectory. As in reality, the trajectory of a feature in a particular person can be affected by the person's characteristics, behaviours, other features, and random factors. When one or more features are considered to be abnormal we say that a person has a disease. Because in reality concepts of abnormality can change, because many diseases are “man made” based solely on the results of tests, because many diseases have multiple and changing definitions, and because diseases can overlap (comorbidities), we typically do not model a disease as though it were a physiological object or state in its own right. Instead we focus on the underlying features (biological variables) that define a disease. For example, “diabetes” is said to be present when fasting plasma glucose>6.9375 mmol/L (125 mg/dL) or oral glucose tolerance test>11.0445 mmol/L (199 mg/d)L. This approach enables the model not only to accommodate different definitions and changes in definitions, but also to test the implications of different definitions. It also addresses comorbidities in a natural way.

The role of a test is to measure the value of one or more features. As features progress, they can cause certain clinical events such as signs, symptoms and health outcomes to occur. Mathematically this is accomplished by triggering the event when the values of a feature, or combination of features, meet certain rules (e.g., reach a particular threshold or suddenly accelerate). The rules that define when events occur can vary from individual to individual, can depend on other features, and can include random factors.

The role of a treatment is to change the value, the rate of progression, or both, of one or more features. The features affected by a treatment are the one's identified through clinical research. For example, in the part of the model that addresses diabetes, the drug Metformin acts on the hepatic production of glucose, triglycerides, and LDL cholesterol—all features in the model. The drug Glyburide stimulates the secretion of insulin by pancreatic beta cells, and affects weight. Diet affects weight, blood pressure, and lipids. Treatments can affect features either indirectly (by changing risk factors) or directly (by changing the feature itself). Treatments that have direct effects can modify either the value of a feature (e.g., performing bypass surgery can open an occluded coronary artery), or can change the rate of change of a feature (e.g., lowering a person's LDL cholesterol will slow the rate of occlusion of a coronary artery).

A final role of features is that the signs, symptoms, and outcomes they cause can set in motion a wide variety of logistic events. These in turn involve other types of objects in the care process and system resource parts of the model.

A complex embodiment my include hundreds of equations. Many, such as the execution of a protocol or the tallying of the costs of a logistic event, are straightforward from a mathematical point of view. To model features, their interactions with other features, their responses to tests and treatments, and their role in causing clinical events, differential equations can be used to describe the rates of changes of the variables as functions of other variables. Every time an event occurs to an object, the differential equations can be integrated to find the time of the next event.

Differential equations are advantageous for modelling many features in this context for at least two reasons. First, they preserve the continuous nature of both time and biological variables. Second, the interrelatedness of features can be captured in a variety of ways. For example, cardiac output (along with arterial compliance, peripheral resistance, and pulse pressure) affects blood pressure, which affects the development of plaque, which can cause an MI (myocardial infarction), which can damage the myocardium, which affects cardiac output. In general, the parameters of the equations are different for every person in the model in a way that reproduces the variability of diseases in a population.

In many cases, some or all of the equations used to advance the simulation in time represent integrated forms (or approximations) of underlying differential equations, and, as a result, no additional numerical approximation is required.

The dynamic modelling approach followed here contrasts with alternative approaches based on Markov models, which have also been applied to healthcare modelling including Diabetes. (See, for example, Herman W H, Hoerger T J, Brandle M, Hicks K, Sorenson, S, Zhang P, Hamman R F, Ackerman R T, Englegau M M, Ratner R E, for the Diabetes Prevention Program Research Group. The Cost-Effectiveness of Lifestyle Modification or Metformin in Preventing Type 2 Diabetes in Adults with Impaired Glucose Tolerance, Annals of Internal Medicine. 2005;142:323-332.)

According to the dynamic modelling approach, the models can be built up incrementally from the underlying anatomy, biological variables and pathways. In this paradigm, biological variables continuously change and interact. Diseases are defined in terms of biological variables. Treatments affect biological variables and pathways. Signs and symptoms are physical and sensory manifestations of biological variables. Outcomes are the culmination of biological variables.

By contrast a Markov model typically represents a disease as consisting of discrete clinical “states” and allows annual transitions (or other limited transitions) between states. Treatments modify chances of transitions between states. Outcomes are associated with entry into states and time spent in states. In general, a number of simplifications and assumptions are necessary in order to represent a complex disease like diabetes through a relatively small number of discrete states and annual transitions between states.

3. Simulation of Clinical Trials

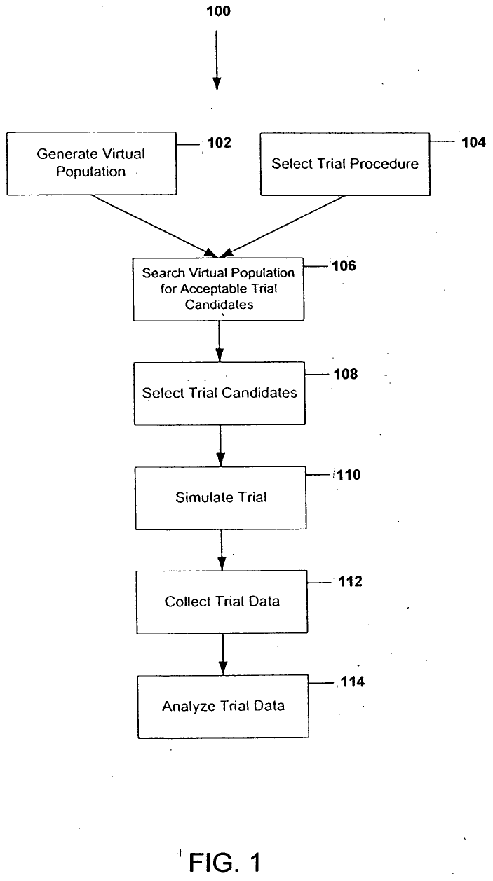

FIG. 1 shows a method 100 for simulating a clinical trial according to an embodiment of the present invention. A virtual population is generated (possibly beforehand) 102 to meet the requirements of the clinical trial, and a trial procedure is selected 104. If necessary the virtual population is searched 106 to determine acceptable trial candidates, and trial candidates are selected 108. Next the trial is simulated 110 and trial data or other results are collected 112 and analyzed 114. Note that determining acceptable candidates in the population can be accomplished in a variety of ways depending on the operational setting including, for example, examining an “initial state” or a “projected dynamic state” of a specific trial candidate.

In this way a “virtual trial” is created by repeating the steps taken in the real trial, and the outcomes seen in the virtual trial 112 can be compared with those that occurred in the real trial. To set up the validation exercises we first have the model create a large virtual population 102 that contains a broad spectrum of ages, sexes, race/ethnicities, characteristics, behaviors, and diseases. This is done by having the model give birth to a very large number of people of different sexes and race/ethnicities and letting them grow up (i.e., letting their physiologies function according to the equations in the model). Information from relevant sources on the marginal and joint distributions of patient characteristics and other risk factors can be used to ensure that the population is representative of the United States population (Third National Health and Nutrition Examination Survey (NHANES III), 1988-1994) CD ROM Series 11, No 1. National Center for Health Statistics, Hyattsville Md.) Alternatively, other populations can be constructed if desired (e.g., an Indian reservation).

To simulate a particular clinical trial we begin with the initial description of the trial 104, focusing in particular on the inclusion and exclusion criteria, the treatment protocols, and the follow up protocols. Then the large virtual population can be searched 106 to identify people who meet the entry criteria for the trial. One can confirm that their characteristics (e.g., age, sex. other conditions, treatments, lab results) match the distribution of characteristics published in the description of the trial, and, if not, over sample or under sample as required, as would occur for a real trial. From that group, people are randomly selected 108 to match the number of people in the trial. At the end of this selection process 108, the distribution of characteristics, biological variables, current and past medical histories, medications, behaviors of the people in the virtual trial should be comparable (e.g., within the sampling error) to what is generally known as “Table 1” of a corresponding real trial. (Diabetes Prevention Program Research Group. Reduction in the incidence of type 2 diabetes with lifestyle intervention or metformin New Engl J Med. 2002;356:393-402.)

Next the trial is simulated 110. Typically this includes randomizing the people into the number of groups used in the trial. If the description of the trial calls for any interventions, such as a diet, to be given before the people are randomized, then that intervention can be applied accordingly. (See, for example, Chiasson J L, Josse R G, Gomis R, Hanefeld M, Karasik A, Laakso M, for the STOP-NIDDM Trial Research Group. Acarbose for the prevention of type 2 diabetes mellitus: the STOP-NIDDM randomized trial. Lancet. 2002;359:2072-2077.) In the simulation simulated provides can give the people in each group the designated treatments, using the protocols described for the trial. The simulation can include options for handling any important breaches in either provider or patient adherence as described for the trial. As the simulation progresses, the people's physiologies continue to function, including the effects of whatever treatments they are receiving. Each patient can be followed with simulated appointments and tests at the intervals used in the real trial. In the model as in the real trial, between scheduled visits patients can also develop symptoms, seek care, make appointments, have visits, be tested, be diagnosed, and be treated.

Data from the simulated trial can be collected 112 during the simulation process 110 or at its termination. Typically results are recorded at the time intervals used in the real trials. Ultimately the results can be analyzed 114 including perhaps a comparison with actual trial data.

The above-described method 100 was used to simulate the CARDS trial, which compared Atorvastatin 10 mg to placebo in people with diabetes and other risk factors for coronary artery disease. (Colhoun H M, Thomason M J, Mackness M I, Maton S M, Betteridge D J, Durrington P N, Hitman G A, Neil H A W, Fuller J H, and the CARDS investigators. Design of the Collaborative Atorvastatin Diabetes Study (CARDS) in patients with type 2 diabetes Diabetic Medicine 19:201-2 11, 2002.) The primary endpoints in this study were major cardiovascular events (e.g., heart failure, stroke). A consistent trial procedure was developed for the simulation 104.

In one specific embodiment, a virtual population was generated 102 by “giving birth” to a large number of simulated people without restriction based on the trial procedure. That is, the simulation did not create a person by simply specifying an age, sex, race/ethnicity, glucose level and so forth, and insert him or her into the simulation, as might be done in the Framingham equation, UKPDS Risk Engine or a Markov model. Rather, the simulation grew each individual up from age=0. The simulated babies spanned a wide distribution not only by sex and race/ethnicity, but by all the other variables that determine people's fates as they grow up, such as behaviours like smoking, genetic propensities to be obese or develop plaque in coronary arteries, and so forth. As each one of these simulated individuals is growing up, their hearts are producing cardiac output, their livers are producing glucose, their beta cells are producing insulin, and so forth. This goes on starting at age zero and continuing over their entire lifetimes. Furthermore, they are living their lives out in a simulated healthcare setting, where simulated physicians respond to their symptoms, do simulated tests, give simulated treatments, comply or fail to comply with guidelines, and so forth. For example, one of the simulated people might get type 1 diabetes at age 10, have complications, and end up dying at age 54 of renal failure. Another one might smoke, not take aspirin, get angina at 45, have a bypass to the LAD, have a hemorrhagic stroke at 56, have a second MI (in the circumflex artery this time) at age 58, get congestive heart failure at 65, live for another 7 years and then die. Eventually some of the simulated people get to the age range where they might be considered for inclusion in a trial like CARDS.

The virtual population was then searched 106 to determine acceptable trial candidates. The general inclusion criteria can be summarized as follows:
A. Type 2 diabetes by the WHO definition;
B. Age 40-75;
C. At least one of: (i) Systolic blood pressure>140 or diastolic blood pressure>90; (ii) Microalbuminurea; (iii) Macroalbuminuria; (iv) Current smoker;
D. LDL less than 8.88 mmol/L (160 mg/dl) and triglycerides<6.78 mmol/L (600 mg/dl);
E. No history of myocardial infarction, angina, cardiovascular surgery, cerebrovascular accident, or severe peripheral vascular disease; and
F. None of the listed exclusions.

From the acceptable trial candidates approximately four-thousand (4,000) people (i.e., “simulated subjects”) were selected 108 as trial candidates. As a confirmation of this selection 108, key characteristics of the simulated subjects were compared with those of the actual CARDS trial subjects. These key characteristics included numerical values for incidence of diabetes, progression of prediabetes to diabetes, progression of diabetes (e.g., rate of increase in FPG (Fasting Plasma Glucose)), rate of myochardial infarctions in people with newly diagnosed diabetes, rate of myocardial infarctions in people with diabetes and high CAD (Coronary Artery Disease) risk, rate of development of albuminuria in people with newly diagnosed diabetes, rate of development of proteinuria in people with newly diagnosed diabetes, Rate of development of ESRD (End-Stage Renal Disease) in people with diabetes and microalbuminurea; rate of development of ESRD in people with newly diagnosed diabetes, rate of development of two-step retinopathy in people with newly diagnosed diabetes, rate of development of legal blindness in people with newly diagnosed diabetes, rate of development of amputations in people with newly diagnosed diabetes, excess direct medical cost for people with diabetes (annual), and direct medical cost for people with prediabetes (annual). If the comparison of the key characteristics had not been acceptable, the selection process 108 could have been adjusted accordingly by adding or deleting simulated subjects in order to achieve an acceptable statistical match.

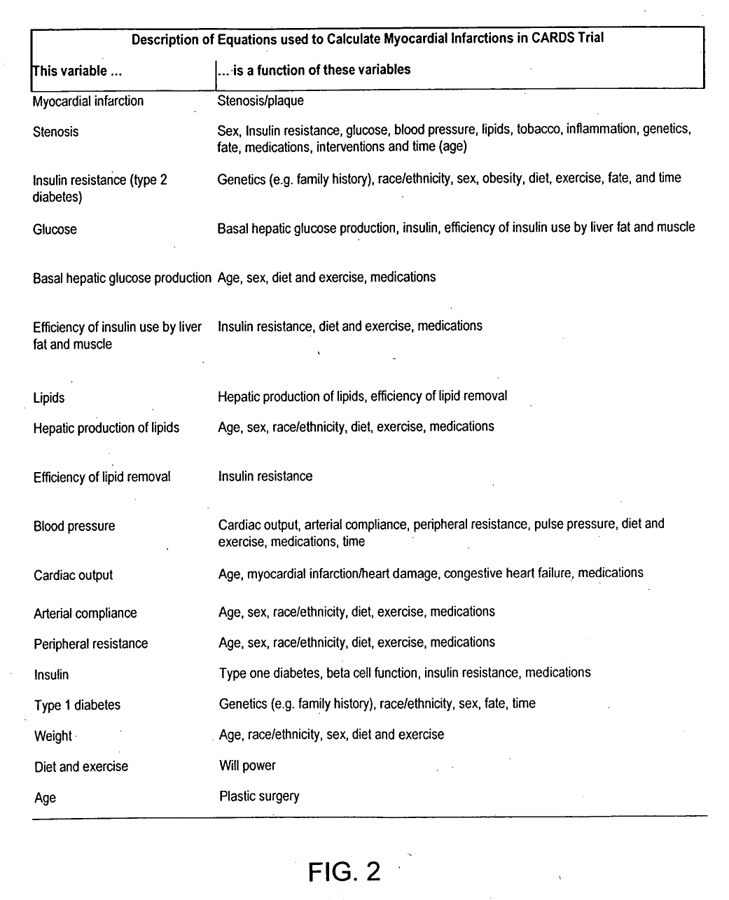

Next the trial was simulated 110 and the trial data were collected 112. This simulation included separation of the simulated subjects into a “control group” and a “treatment group.” According to the trial procedure 104, simulated providers gave a placebo to the control group and gave Atorvastatin 10 mg to the treatment group. The simulated model included hundreds of equations. For example, FIG. 2 summarizes the equations related to the prediction of an MI (myocardial infarction). These include equations for: myocardial infarction, stenosis, insulin resistance for type 2 diabetes, glucose, basal hepatic glucose production, efficiency of insulin use by liver fat and muscle, lipids, hepatic production of lipids, efficiency of lipid removal, blood pressure, cardiac output, arterial compliance, peripheral resistance, insulin, type 1 diabetes, weight, diet and exercise, and age. These details are intended to illustrate a particular combination of models (e.g., as discussed in U.S. application Ser. No. 10/763,653); however, specific modelling choices will be made by one skilled in the art according to the specific requirements of a clinical study or other operational setting.

In simulating the trial 110, simulated subjects were followed for five years in simulated time, with follow-up examinations every six months. At the six-monthly checkpoints, each simulated subject was evaluated for the primary outcomes of the trial, the main one of which was major coronary events, consisting of sudden cardiac deaths (defined as a death that occurs within one day of the onset of MI (myocardial infarction)), non-sudden cardiac deaths (a death occurring more than one day following a myocardial infarction), and non-fatal myocardial infarctions including silent MIs. Trial data were collected 112 at these examination points.

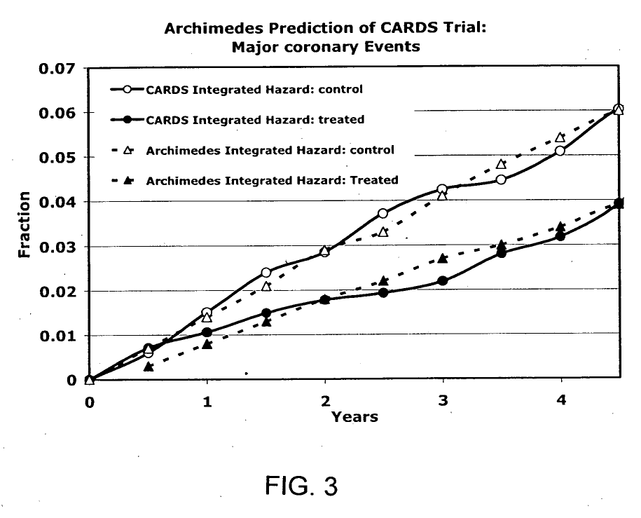

At the end of the simulation the trial data were analyzed 114 to predict a hazard (i.e., a major coronary event) for the control group and the treated group. These results are shown together with corresponding results of the actual CARDS trial in FIG. 3. Notably, the simulated results were determined before the actual results were announced.

As shown in FIG. 3, the accuracy of the prediction for the control group confirms such things as the model's representation of the anatomy and physiology of coronary artery disease (e.g., anatomy of coronary arteries, progression of plaque, etc.), and the effects of such factors as patient characteristics (e.g., age, sex race/ethnicity), past medical history, current conditions, duration and severity of disease, co-morbidities, and current medications. The model's accuracy for the treated group confirms the model's representation of the biological effects of atorvastatin 10 mg on cholesterol and the extra-cholesterol (pleotropic) effects of atorvastatin on development of plaque in coronary arteries. Because the simulation began with the birth of the simulated participants, the results also test the long term stability and realism of the physiology equations.

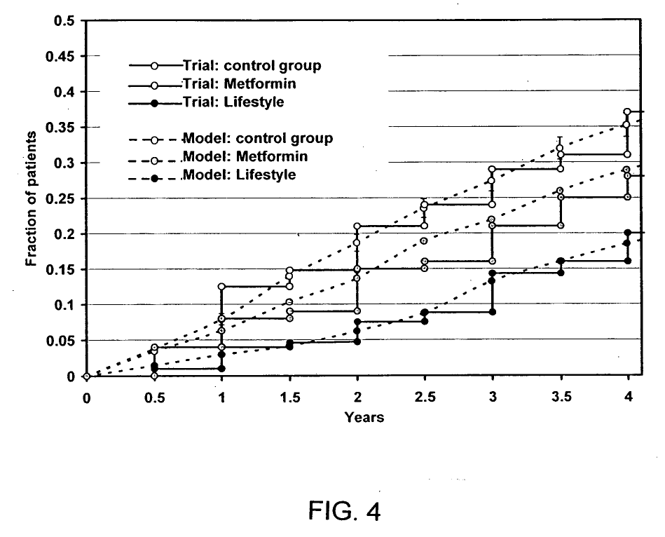

FIGS. 4-7 show results of additional exemplary embodiments applied to diabetes management and prevention. Details of the corresponding method steps 100 are analogous to those for the CARDS trial illustrated in FIG. 3.

FIG. 4 shows a simulation related to the Diabetes Prevention Program (DPP) in which people who were at high risk of diabetes but did not yet have the disease as it is currently defined were given either lifestyle modification, metformin or placebo. For obvious reasons it is important that the model be able to predict the results of that trial. In our case, we used the simulation model to perform a prospective, independent, blinded prediction of the DPP's results. The trial procedure was determined 104 based on initial descriptions of the DPP trial. (The Diabetes Prevention Research Group. “The Diabetes Prevention Program: baseline characteristics of the randomized cohort.” Diabetes Care. 2000;23:1619-1629; The Diabetes Prevention Research Group. “The Diabetes Prevention Program: design and methods for a clinical trial in the prevention of type 2 diabetes.” Diabetes Care. 1999;22:623-634.). The trial was simulated 110 and the results were predicted 114 before the publication of the real trial results. (Diabetes Prevention Program Research Group. “Reduction in the incidence of type 2 diabetes with lifestyle intervention or metformin” New Engl J Med. 2002;356:393-402.) As illustrated in FIG. 4, the rates of diabetes in the placebo, metformin and Lifestyle groups predicted by the model at three years were 27.4%, 21.9% and 13.2% respectively. Also, as illustrated in FIG. 4, the reported trial results at three years were 28.9%, 21.7% and 14.4%, respectively.

Another critical aspect of this analysis is the rate of progression of the disease in people with prediabetes or diabetes. Disease progression in the model was validated by comparing the rates of increase of FPG calculated by the model to those observed in the control groups of the DPP and the UK Prospective Diabetes Study UKPDS.

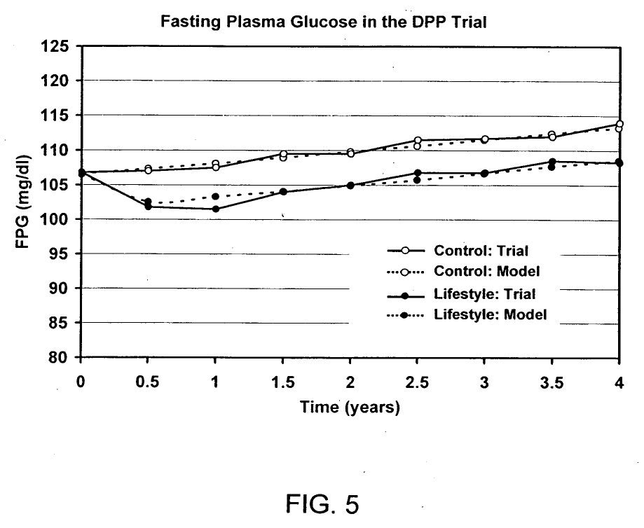

In the DPP, the average FPG was approximately 5.9385 mmol/L (107 mg/dl) at the start of the trial and increased to approximately 6.327 mmol/L (114 mg/dl) after four years. (Diabetes Prevention Program Research Group. “Reduction in the incidence of type 2 diabetes with lifestyle intervention or metformin” New Engl J Med. 2002;356:393-402.) The FPG levels calculated by the model were 5.91075 mmol/L (106.5 mg/dl) and 6.2882 mmol/L (113.3 mg/dl), respectively. These results are illustrated in FIG. 5.

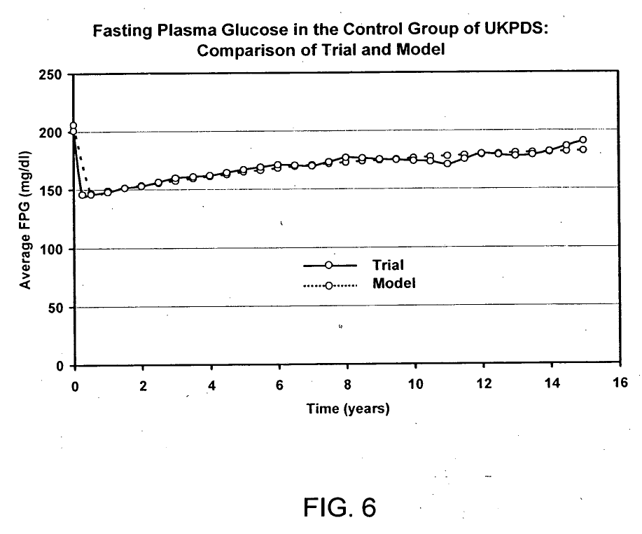

For the UKPDS, the average FPG levels were 11.1555 mmol/L (201 mg/dl) at presentation, 8.103 mmol/L (146 mg/dl) after an initial diet, and 10.101 mmol/L (182 mg/dl) at fourteen years. (UK Prospective Diabetes Study (UKPDS) Group. “Intensive blood-glucose control with sulphonylureas or insulin compared with conventional treatment and risk of complications in patients with type 2 diabetes (UKPDS 33).” Lancet. 1998;352:837-852; Colagiuri S, Cull C A, Holman R R; for the UKPDS Group. “Are lower fasting plasma glucose levels at diagnosis of type 2 diabetes associated with improved outcomes? (UKPDS 61).” Diabetes Care. 2002;25:1410-1417; UK Prospective Diabetes Study (UKPDS) Group. “United Kingdom Prospective Diabetes Study “Relative Efficacy Of Randomly Allocation To Diet, Sulphonylurea, Insulin Or Metformin In Patients With Newly Diagnosed And Non-Insulin Dependent Diabetes Followed For 3 Years (UKPDS 13).” BMJ 1995; 310;83-8.) The numbers calculated by the model were 11.433 mmol/L (206 mg/dl), 8.1585 mmol/L (147 mg/dl), and 10.0455 mmol/L (181 mg/dl), respectively. These results are illustrated in FIG. 6.

The model also has been used to verify that the rates of increase of FPG are relatively constant across the entire range of FPG levels (i.e., there are no sharp accelerations or decelerations). An analysis of UKPDS data for three strata of FPG levels at presentation ranging from <6.993 mmol/L (126 mg/dl) to >13.32 mmol/L (240 mg/dl) confirms this to be true. (Harris M I, Klein R, Welborn T A, Knuiman M W. “Onset of NIDDM Occurs at least 4-7-years before clinical diagnosis.” Diabetes Care 1992, 15; 815-819.)

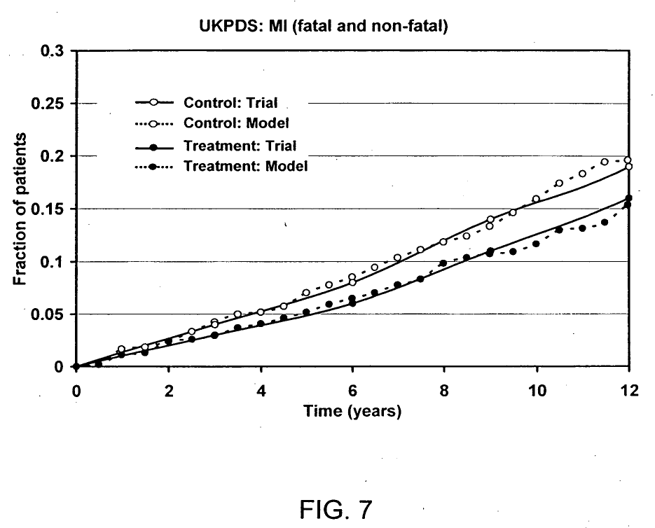

An example of the model's accuracy in calculating long term outcomes is illustrated in FIG. 7, which compares the rate of myocardial infarctions calculated by the model for simulated people with newly diagnosed diabetes versus the rates seen in the above-cited UKPDS studies. In this trial, all patients were put on a diet that lowered their FPGs, before being randomized to the two treatment groups.

As illustrated by the embodiments described above, the present invention enables the simulation of clinical trials and other clinical experiences and thereby enables healthcare model development and validation. All the important, clinical, and procedural factors that are part of a design of a trial, such as the inclusion criteria, treatment and testing protocols, biological outcomes, and health outcomes, can be handled at a level of detail that is consistent with the corresponding specifications of the trial.

4. Conclusion

The above-described embodiments demonstrate a wide applicability of the present invention for healthcare modelling. Taken together they span temporal ranges from periods with no disease symptoms in individuals through occurrences of late complications, which may occur several decades after the first observable disease symptoms. The validations also span a variety of populations, organ systems, interventions and outcomes. Additionally, these embodiments can be extended to address the interactions between diseases and comorbidities. To accomplish this, one can employ a single integrated model of biology from which all the relevant diseases in the model arise, so that the important interactions can be realistically represented. Furthermore, to help set priorities and strategic goals, a wide range of interventions and a wide range of diseases can be simultaneously studied.

Additional embodiments relate to an apparatus that includes a computer that executes computer instructions for carrying out any one of the above-described methods. In this context the computer may be a general-purpose computer including, for example, a processor, memory, storage, and input/output devices (e.g., monitor, keyboard, disk drive, Internet connection, etc.). However, the computer may include a specialized microprocessor or other hardware for carrying out some or all aspects of the methods. Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method for simulating a clinical trial, comprising:
selecting a trial procedure for a simulated trial corresponding to the clinical trial;
generating a population of subjects for the simulated trial;
searching the population of subjects to determine acceptable subjects for the simulated trial;
selecting subjects for the simulated trial from the acceptable subjects;
simulating the trial procedure for the selected subjects; and
collecting trial data for the simulated trial from the simulated trial procedure.

2. A method as claimed in claim 1, wherein selecting the trial procedure for the simulated trial includes:
determining one or more criteria for inclusion or exclusion of the subjects; and
determining one or more treatment protocols for the subjects.

3. A method as claimed in claim 2, wherein the one or more criteria include a range for fasting plasma glucose (FPG).

4. A method as claimed in claim 1, wherein generating the population of subjects for the simulated trial includes: determining one or more parameters for characterizing the subject at an initial state of the simulated trial, wherein the or more parameters satisfy a statistical criterion for a population corresponding to the clinical trial.

5. A method as claimed in claim 4, wherein the statistical criterion includes a coronary death rate.

6. A method as claimed in claim 1, wherein searching the population of subjects to determine acceptable subjects for the simulated trial includes: comparing features of subjects with criteria from the trial procedure.

7. A method as claimed in claim 6, wherein the criteria from the trial procedure include a positive characterization of diabetes.

8. A method as claimed in claim 1, wherein selecting subjects for the simulated trial from the acceptable subjects includes:
selecting a pre-determined number of subjects for the simulated trial;
confirming the selection by determining at least one statistical criterion for accepting the selected subjects; and
adjusting the selected subjects if the at least one statistical criterion is not satisfied.

9. A method as claimed in claim 8, wherein the at least one statistical criterion includes a characterization for the incidence of diabetes.

10. A method as claimed in claim 1, wherein simulating the trial procedure for the selected subjects includes:
separating the subjects into at least two groups, including a control group and a treatment group, wherein the trial procedure includes a control-group trial procedure for the control group and treatment-group trial procedure for the treatment group; and
advancing a temporal variable to determine at least one trial event specified by the trial procedure

11. A method as claimed in claim 10, wherein the at least one trial event includes a glucose measurement for at least one subject.

12. A method as claimed in claim 10, wherein the at least one trial event includes a coronary event for at least one subject.

13. A method as claimed in claim 1, wherein collecting trial data for the simulated trial includes recording values for fasting plasma glucose (FPG) of the subjects at a plurality of times.

14. A method as claimed in claim 1, further comprising:
analyzing the trial data from the simulated trial procedure to determine a comparison between the trial data and a set of clinical results from the clinical trial.

15. A method as claimed in claim 14, wherein the comparison includes a comparison of coronary events between the simulated trial and the clinical trial.

16. An apparatus for simulating a clinical trial, the apparatus comprising a computer for executing computer instructions, wherein the computer includes computer instructions for:
selecting a trial procedure for a simulated trial corresponding to the clinical trial;
generating a population of subjects for the simulated trial;
searching the population of subjects to determine acceptable subjects for the simulated trial;
selecting subjects for the simulated trial from the acceptable subjects;
simulating the trial procedure for the selected subjects; and
collecting trial data for the simulated trial from the simulated trial procedure.

17. An apparatus as claimed in claim 16, wherein selecting the trial procedure for the simulated trial includes:
determining one or more criteria for inclusion or exclusion of the subjects; and
determining one or more treatment protocols for the subjects.

18. An apparatus as claimed in claim 17, wherein the one or more criteria include a range for fasting plasma glucose (FPG).

19. An apparatus as claimed in claim 16, wherein generating the population of subjects for the simulated trial includes: determining one or more parameters for characterizing the subject at an initial state of the simulated trial, wherein the or more parameters satisfy a statistical criterion for a population corresponding to the clinical trial.

20. An apparatus as claimed in claim 19, wherein the statistical criterion includes a coronary death rate.

21. An apparatus as claimed in claim 16, wherein searching the population of subjects to determine acceptable subjects for the simulated trial includes: comparing features of subjects with criteria from the trial procedure.

22. An apparatus as claimed in claim 21, wherein the criteria from the trial procedure include a positive characterization of diabetes.

23. An apparatus as claimed in claim 16, wherein selecting subjects for the simulated trial from the acceptable subjects includes:
selecting a pre-determined number of subjects for the simulated trial;
confirming the selection by determining at least one statistical criterion for accepting the selected subjects; and
adjusting the selected subjects if the at least one statistical criterion is not satisfied.

24. An apparatus as claimed in claim 23, wherein the at least one statistical criterion includes a characterization for the incidence of diabetes.

25. An apparatus as claimed in claim 16, wherein simulating the trial procedure for the selected subjects includes:
separating the subjects into at least two groups, including a control group and a treatment group, wherein the trial procedure includes a control-group trial procedure for the control group and treatment-group trial procedure for the treatment group; and
advancing a temporal variable to determine at least one trial event specified by the trial procedure

26. An apparatus as claimed in claim 25, wherein the at least one trial event includes a glucose measurement for at least one subject.

27. An apparatus as claimed in claim 25, wherein the at least one trial event includes a coronary event for at least one subject.

28. An apparatus as claimed in claim 16, wherein collecting trial data for the simulated trial includes recording values for fasting plasma glucose (FPG) of the subjects at a plurality of times.

29. An apparatus as claimed in claim 16, wherein the computer further includes computer instructions for:
analyzing the trial data from the simulated trial procedure to determine a comparison between the trial data and a set of clinical results from the clinical trial.

30. An apparatus as claimed in claim 29, wherein the comparison includes a comparison of coronary events between the simulated trial and the clinical trial.

31. An apparatus as claimed in claim 16, wherein the computer includes a processor with memory for executing at least some of the computer instructions.

32. A computer-readable medium that stores a computer program for simulating a clinical trial, wherein the computer program includes instructions for:
selecting a trial procedure for a simulated trial corresponding to the clinical trial;
generating a population of subjects for the simulated trial;
searching the population of subjects to determine acceptable subjects for the simulated trial;
selecting subjects for the simulated trial from the acceptable subjects;
simulating the trial procedure for the selected subjects; and
collecting trial data for the simulated trial from the simulated trial procedure.

33. A computer-readable medium as claimed in claim 32, wherein selecting the trial procedure for the simulated trial includes:
determining one or more criteria for inclusion or exclusion of the subjects; and
determining one or more treatment protocols for the subjects.

34. A computer-readable medium as claimed in claim 33 wherein the one or more criteria include a range for fasting plasma glucose (FPG).

35. A computer-readable medium as claimed in claim 32, wherein generating the population of subjects for the simulated trial includes: determining one or more parameters for characterizing the subject at an initial state of the simulated trial, wherein the or more parameters satisfy a statistical criterion for a population corresponding to the clinical trial.

36. A computer-readable medium as claimed in claim 35, wherein the statistical criterion includes a coronary death rate.

37. A computer-readable medium as claimed in claim 32, wherein searching the population of subjects to determine acceptable subjects for the simulated trial includes: comparing features of subjects with criteria from the trial procedure.

38. A computer-readable medium as claimed in claim 37, wherein the criteria from the trial procedure include a positive characterization of diabetes.

39. A computer-readable medium as claimed in claim 32, wherein selecting subjects for the simulated trial from the acceptable subjects includes:
selecting a pre-determined number of subjects for the simulated trial;
confirming the selection by determining at least one statistical criterion for accepting the selected subjects; and
adjusting the selected subjects if the at least one statistical criterion is not satisfied.

40. A computer-readable medium as claimed in claim 39, wherein the at least one statistical criterion includes a characterization for the incidence of diabetes.

41. A computer-readable medium as claimed in claim 32, wherein simulating the trial procedure for the selected subjects includes:
separating the subjects into at least two groups, including a control group and a treatment group, wherein the trial procedure includes a control-group trial procedure for the control group and treatment-group trial procedure for the treatment group; and
advancing a temporal variable to determine at least one trial event specified by the trial procedure

42. A computer-readable medium as claimed in claim 41, wherein the at least one trial event includes a glucose measurement for at least one subject.

43. A computer-readable medium as claimed in claim 41, wherein the at least one trial event includes a coronary event for at least one subject.

44. A computer-readable medium as claimed in claim 32, wherein collecting trial data for the simulated trial includes recording values for fasting plasma glucose (FPG) of the subjects at a plurality of times.

45. A computer-readable medium as claimed in claim 32, wherein the computer program further comprises instructions for:
analyzing the trial data from the simulated trial procedure to determine a comparison between the trial data and a set of clinical results from the clinical trial.

46. A computer-readable medium as claimed in claim 45, wherein the comparison includes a comparison of coronary events between the simulated trial and the clinical trial.
